(19) United States
(12) Patent Application Publication
(10) Pub. No.: US 2025/0003168 A1
(43) Pub. Date: Jan. 2, 2025

(54) Joints for Pre-Cast Driven Piles

(71) Applicant: NORWEGIAN UNIVERSITY OF SCIENCE AND TECHNOLOGY, Trondheim (NO)

(72) Inventors: Habibollah SADEGHI, Trondheim (NO); Rao Martand SINGH, Trondheim (NO)

(73) Assignee: NORWEGIAN UNIVERSITY OF SCIENCE AND TECHNOLOGY, Trondheim (NO)

(21) Appl. No.: 18/710,355

(22) PCT Filed: Nov. 15, 2022
(86) PCT No.: PCT/EP2022/082031

§ 371 Date: May 15, 2024

(30) Foreign Application Priority Data
Nov. 15, 2021 (GB) 2116447.0

(51) Int. Cl. E02D 5/52; F24T 10/10

(52) U.S. Cl. CPC E02D 5/526; F24T 10/10; E02D 2300/002; E02D 2600/20

(57) ABSTRACT

A first part of a joint for joining pre-cast driven geothermal pile segments comprises a cap having an end plate and a peripheral wall extending from a periphery of the end plate, the end plate and peripheral wall defining a volume; and at least two apertures passing through the cap, wherein each aperture provides a passage from an inside of the cap to an outside of the cap; and wherein each aperture is provided within a recess in the peripheral wall such that each aperture is thereby recessed within the volume defined by the end plate and the peripheral wall. The apertures being recessed ensures that they, and any fluid connection made thereat, are shielded from any damage and the harsh forces involved in the installation of the driven pile segments.

The present invention relates to a part of a joint for joining pre-cast driven pile segments, more specifically pre-cast driven geothermal pile segments. The invention further extends to a joint comprising the part, and further extends to underground geothermal energy structures comprising said joints. The invention also relates to methods of using, manufacturing and assembling the same.

Piles are typically used to provide foundational support to buildings/structures that have a length to diameter ratio of approximately 10 or larger. Piles are deep foundations that transfer building loads to the deep ground layers to ensure the stability of the over-ground structures. A prevalently used type of pile is a concrete pile. Concrete piles can be divided into two main groups: cast-in-place piles (or sometimes termed bored piles) and pre-cast piles.

A cast-in-place pile, as the name suggests, is constructed at the site of the building/structure. A borehole for the pile is formed, a reinforcement cage is then placed in the borehole, and concrete is subsequently poured into the borehole where it sets and solidifies to provide the pile.

A pre-cast pile is one which is constructed prior to arriving at the site of the building/structure. The pre-cast pile is manufactured in a cast, generally in concrete or steel factories, and is then transported to a construction site of the building/structure. Typically pre-cast piles are of a driven type, and are thus driven into the ground without the need for prior construction of any boreholes.

A further type of pre-cast pile is known from, e.g., CN 210341889 U. The pre-cast piles of the type disclosed in this document are not of a driven type nor are they suitable for use as a driven pile since they do not have the requisite mechanical properties (e.g. strength, resistance to highly attritional forces, etc.) that are required for driven piles. Instead, pre-cast piles of the type disclosed in CN 210341889 U are installed within a pre-formed borehole. Concrete or other filler is then introduced into the borehole to fill the annular space between the borehole and pile to seal the pile in place. The pile structure resulting from the use of these types of piles reduces the lateral friction of the piles with the ground as compared to piles of the driven type. They thus provide a poorer support. Piles of this type are not known to be used in Europe, the USA or outside of China.

Pre-cast piles of the driven type (i.e. driven piles) have length limits due to the need for transportation (usually their length being limited to between 12 m-15 m in accordance with the limits of the transportation vehicles). Therefore, several pre-cast driven pile segments can be joined end-to-end via the use of joints to form a pile structure, which allows for a longer foundational support to be provided underground and thereby allows for taller/larger buildings and structures to be supported.

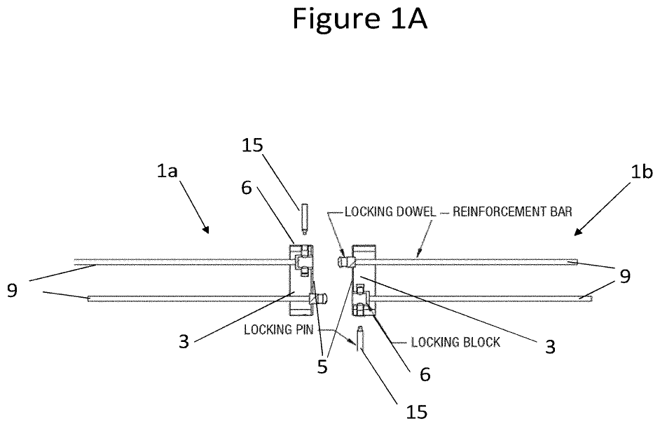

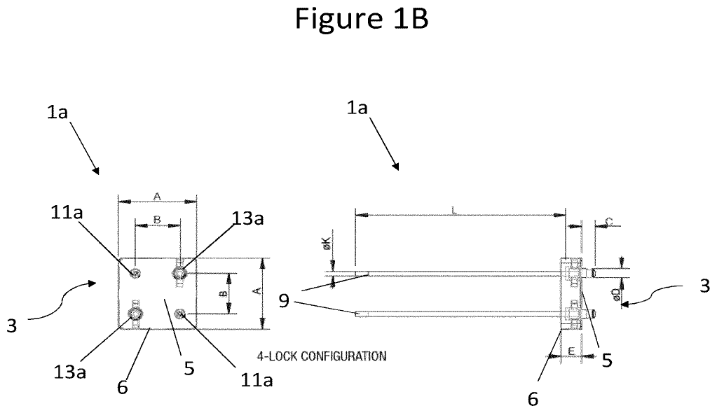

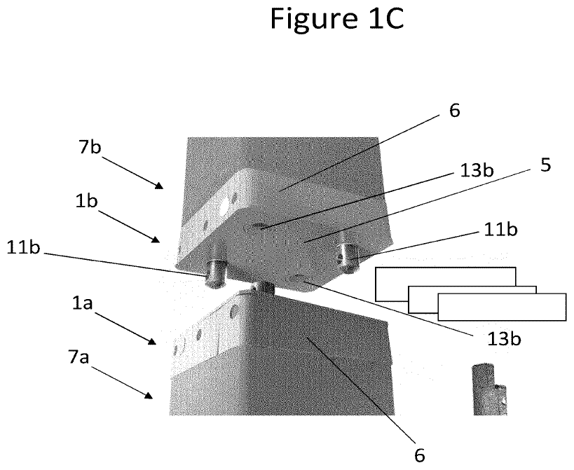

An exemplary joint prevalently used for joining driven pre-cast concrete pile segments is manufactured and sold by Leimet Oy under the name Leimet ABB PLUS joint. A depiction of this joint can be seen in FIGS. 1A-1C.

As shown in these Figures, the joint comprises two parts: a first part 1a and a second part 1b. Each of the parts 1a, 1b comprises a cap 3 having an end plate 5 with a peripheral wall 6 extending from a periphery thereof. When viewed from the end plate 5, the cap 3 can be seen to have a square cross-section that matches that of driven pile segments 7a, 7b (see FIG. 1C). The cap 3 is fixed to an axial end of a pre-cast driven pile segment 7a, 7b during casting of the driven pile segments 7a, 7b. In this way, the interior defined between the end plate 5 and peripheral wall 6 is filled with the concrete of a pile segment 7a, 7b during the casting of the pile segment and an inside surface of the end plate 5 mates to an axial end surface of the driven pile segment 7a, 7b whilst the peripheral wall 6 extends along an outer, peripheral surface of the driven pile segment 7a, 7b.

Attached to and extending from an inside surface of the end plate 5 of each part 1a, 1b (i.e. inside the cap 3) are a plurality of reinforcement bars 9 which, when the cap 3 is attached as part of the pile segments 7a, 7b, are embedded within the concrete of the pile segments 7a, 7b to provide reinforcement thereto and to assist in holding the cap 3 in place on the end of the pile segments 7a, 7b.

Two protrusions (otherwise termed locking dowels) 11a, 11b and two indentations (otherwise termed locking blocks) 13a, 13b are also provided on the end plate 5 of each part 1a, 1b, on a second side of the cap 3 opposed to that side on which the reinforcement bars 9 are provided (i.e. the outside of the cap 3). The two protrusions 11a on the first part 1a are configured to be received within the two indentations 13b on the second part 1b and the two protrusions 11b on the second part 1b are configured to be received within the two indentations 13a on the first part 1a when the joint is joined together.

A channel is provided in each protrusion 11a, 11b which, when each protrusion 11a, 11b is inserted in a corresponding indentation 13a, 13b, align with a correspondent channel in each indentation 13a, 13b. The channels of the protrusions 11a, 11b and the indentations 13a, 13b once aligned allow for the insertion of a locking pin 15 (one locking pin 15 for each coupled protrusion 11a, 11b and indentation 13a, 13b). The insertion of the locking pin 15 locks each protrusion 11a, 11b to each indentation 13a, 13b and thereby locks the first part 1a and the second part 1b, and thereby the piles segments 7a, 7b together.

The Leimet ABB PLUS joint as described above is the most prevalently used joint for pre-cast driven piles in Europe. It is also prevalently used in the USA and Australia. This is because this joint has been demonstrated to have the requisite robustness to withstand the forces needed as part of a pre-cast driven pile structure.

Whilst the Leimet ABB PLUS joint is prevalently used, other joints and joining techniques for pre-cast driven piles are known. For example, simple welding techniques to join a first part and second part of a joint together can be used to create a joint between two pre-cast driven pile segments. The welded joint between the first and second parts of the joint would/could be used in place of the protrusions, indentations, locking pins and channels of the Leimet ABB PLUS joint.

Pre-cast driven piles are advantageous over cast-in-place piles for a number of reasons. Firstly, higher quality assurance/quality control of pre-cast piles can be obtained since they are manufactured in a controlled factory setting.

Pre-cast driven piles also require no borehole construction and hence they can be driven into the ground up to the desired depth to provide enough bearing capacity for the over-ground structures which they are configured to support. In contrast, cast-in-place piles require borehole construction prior to the construction of the pile. The construction of said boreholes becomes significantly more expensive at larger depths, which thereby imposes a constraint on the maximum depth to which cast-in-place piles can feasibly be used.

Pre-cast driven piles can also provide support below the groundwater table both more safely and more cheaply than their cast-in-place counterparts since the concrete in pre-cast piles is solidified prior to installation into the ground. Whilst cast-in-place piles can be constructed below the ground water table, such construction either requires steel casings which are associated with additional expense or requires the use of a drilling fluid, such as bentonite, which may reduce the pile load carrying capacity as the bentonite becomes mixed with concrete. Bentonite is also harmful for the environment and creates groundwater pollution.

Pre-cast driven piles also afford a simpler and quicker construction procedure with less equipment required than for cast-in-place piles. Pre-cast driven piles are also more environmentally friendly, and they create little to no soil waste, which is of particular importance when used in polluted grounds (also known as brown fields). Pre-cast driven piles can also, effectively, be universally used since they are suitable for use in almost all ground conditions.

It is known to be desirable to use piles as geothermal energy structures since (relatively shallow) geothermal energy is a cheap, clean, renewable and hence very attractive source of energy for both commercial and residential buildings. More and more countries are imposing requirements on new buildings and structures which mandate the exploitation of such geothermal energy for heating and cooling.

Geothermal energy structures rely on the difference between the surface temperature and the temperature below the surface of the earth for the transfer of energy. When used as geothermal energy structures, piles are used as a primary unit in a ground source heat pump system to exchange heat with the ground, i.e., for heating and cooling purposes of buildings.

A geothermal pile structure (i.e. a pile structure configured for harvesting geothermal energy) comprises one or more fluid loops, formed from pipes, providing a passage for fluid (conventionally water or water combined with antifreeze) to be circulated down through the pile and then back to the surface. The fluid (water) absorbs/emits heat to the ground (dependent on the relative temperature between the two) whilst within the pile as it is circulated through the fluid loop. The fluid then resurfaces from the pile and is transferred to a heat pump unit for the transfer of thermal energy thereat.

Given the above advantages associated with pre-cast driven piles and pre-cast driven pile structures (i.e. structures formed from segments of pre-cast driven piles) it would be desirable to have geothermal energy structures formed from a plurality of pre-cast driven pile segments joined together. However, to date, geothermal pile structures are almost exclusively of the cast-in-place type. Pre-cast driven geothermal piles (i.e. piles configured for harvesting geothermal energy) formed from a single pile unit are also known; however these have limited applicability for larger over-ground structures given their limited length and are thus not prevalently used. To date, pre-cast driven geothermal pile structures are extremely limited in number since there is not yet available a joint for pre-cast driven geothermal piles which both allows a suitable fluid connection between adjacent pre-cast driven pile segments and which is also sufficiently robust (both in terms of the connection it provides and in itself) to withstand the harsh forces involved during installation of pre-cast driven piles.

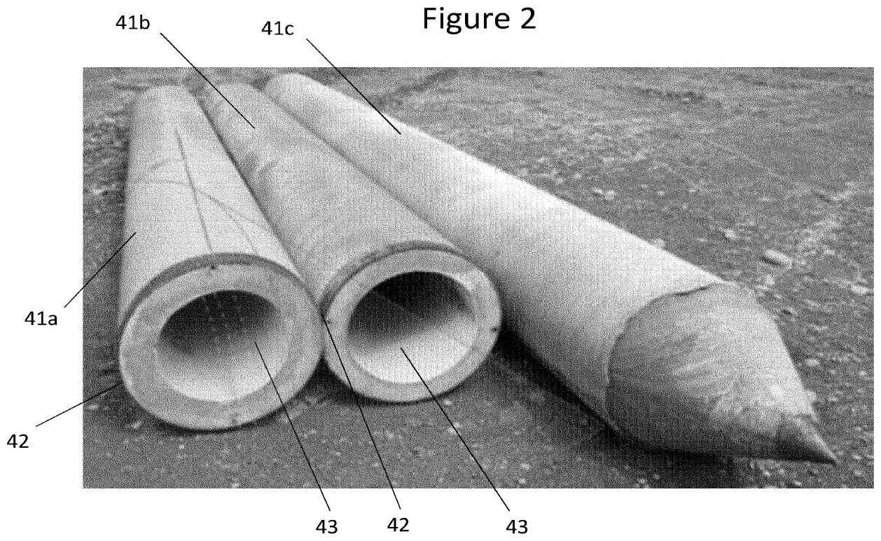

A known geothermal energy structure formed from driven pre-cast pile units is available from Marti Techniques de Foundation SA and is shown in FIG. 2. Three driven piles units 41a-41c, including a distal, foot pile 41c, which is intended to form the bottom of the pile structure once installed, are shown. Each driven pile unit 41a-41c is formed with a centralised bore 43 and further comprises a steel ring 42 situated at each of its axial ends that are configured to be joined to an adjacent unit. The units 41a-41c are joined together by welding two adjacent steel rings 42 on two adjacent pile units 41a-41c. This results in a continuous conduit through the pile structure and thereby enables for a suitable fluid circuit to be installed therein. Once the fluid circuit is installed, a filler material (e.g. concrete or bentonite) may then be introduced within the conduit of the pile structure to fill the remaining volume. The pile units 41a-41c are formed using a specialised concrete centrifuge.

The central bore 43, whilst permitting the presence of a fluid circuit, introduces structural weaknesses to each of the pile units 41a-41c given the large hollow space/the absence of pre-cast concrete therein. Whilst the filler material that is introduced during installation of the pile structure may partly negate these structural weaknesses, it will not fully negate them. As such, the resultant pile structure will have low resistance to damage (especially whilst the pile unit is being driven into the ground). Moreover, the centrifuge used to form the pile units 41a-41c can only produce pile units 41a-41c of limited diameters which means that the pile units 41a-41c have limited applicability for supporting larger/taller over-ground structures.

EP 3358085 A1 discloses pile segments that can be connected to form a geothermal pile structure. Adjacent pile segments are joined directly to one another without the use of a joint, plate or similar structure for facilitating the attachment of the adjacent pile segments together. Heat transfer pipes embedded within each pile segment pass directly through the concrete at the axial end of the pile segment and are joined to heat transfer pipes in an adjacent pile segment through the use of a connecting piece. The connecting piece is configured to be compressed between joined pile segments so as to form a seal therebetween.

WO 03/023150 discloses pile segments that can be connected to form a geothermal pile structure. Adjacent pile segments are joined using a first cap affixed to a first pile segment and a second cap affixed to a second pile segment. The first cap has a heightened centre portion that is configured to be received within a recessed centre portion in the second cap to form a close-fit and mated connection between the two caps. Openings are provided centrally in the heightened centre portion of the first cap and in the recessed centre portion of the second cap which permit a thermal fluid circuit to be established between the adjacent segments.

According to a first aspect of the present invention, there is provided a first part of a pile joint for joining pre-cast driven geothermal pile segments (i.e. pile segments configured for harvesting geothermal energy), the first part comprising: a cap having an end plate and a peripheral wall extending from a periphery of the end plate, the end plate and peripheral wall defining a volume; and at least two apertures passing through the cap, wherein each aperture provides a passage from inside (i.e. a first side) of the cap to outside (i.e. a second opposed side) of the cap; and wherein each aperture is provided within a recess in the peripheral wall such that each aperture is recessed within the volume defined by the end plate and the peripheral wall.

The cap of the first part of the pile joint is configured to be fitted at/integrated with an axial end of a pre-cast geothermal pile segment during the casting process of said segment such that an inside surface of the end plate mates to an axial end surface of the pre-cast pile whilst the peripheral wall extends along an outer surface of the pre-cast pile. As such, an end part of the pile segment (conventionally and optionally formed from concrete) is configured to fill the inside of the cap defined between the peripheral wall and the end plate once the first part is situated thereon.

The first part of the pile joint as defined in the first aspect of the invention is advantageous since, when provided on a pre-cast pile segment, it enables a two-part fluid connection to an adjacent pre-cast pile segment comprising a corresponding second part of the pile joint to be established. This is by virtue of the at least two apertures provided in the first part of the joint, which are each configured to permit a fluid pipe/conduit to extend therethrough. As such, each aperture may permit for a fluid (e.g. water or water mixed with anti-freeze) pipe/conduit that is embedded in the material of the pile segment to pass through the first part of the joint to an exterior of the pile segment such that it can be connected to a fluid pipe/conduit in an adjacent pile segment.

As will be appreciated by the skilled person, at least a two-part fluid connection between adjacent pile segments is required for a geothermal pile structure to be formed since a fluid loop needs to be established for the fluid travelling both down and up the geothermal structure. Given the first part of the pile joint of the first aspect enables such a two-part connection by virtue of the presence of the at least two apertures, it can be used to achieve geothermal pile structures formed from more than one pre-cast pile segment. That is, the two-part fluid connection provided by virtue of the first part of the pile joint allows for the necessary fluid loop for a geothermal pile structure to be achieved.

Geothermal pile structures formed from multiple pre-cast driven pile segments are advantageous for the reasons discussed above and thus the first part of the joint of the first aspect of the invention is advantageous since it permits such geothermal pile structures to be realised.

However, the first part of the pile joint of the first aspect provides further advantages when comprised as part of a pile joint in a geothermal pile structure as discussed in further detail below.

Firstly, since the first part of the pile joint according to the first aspect requires that each aperture is recessed within the peripheral sidewall and thereby recessed within the volume defined by the end surface and the peripheral wall, an inherent protection is provided to the aperture, and thereby any fluid conduit protruding therefrom, by the cap of the first part. That is, the surrounding volume of the cap provides a shielding effect to the apertures since the apertures are embedded within the volume of the cap by virtue of their recessed arrangement. Thus, any fluid connection made at or proximate the aperture may be similarly shielded by the cap and thus has low susceptibility to being interfered with/damaged by the highly attritional and harsh forces (e.g. side friction) involved in the installation and use of pre-cast driven geothermal pile structures. As such, a structurally effective and fluid-tight connection can be maintained between adjacent geothermal pile segments. A similarly effective and fluid-tonight connection is not provided by the arrangement disclosed in WO 03/023150 since a similar protection is not provided to the fluid connection made between adjacent segments. In contrast, the fluid connection is made directly at the interface of the two opposed adjacent pile segments in WO 03/023150.

Furthermore, and since the apertures are recessed within the volume of the cap by virtue of their recessed arrangement in the peripheral wall, a protected working space around the apertures is provided for. This enables easy and simple installation of any fluid connection made at or proximate the aperture. This space also permits for a deformation of any fluid conduits/fluid connection within the recess that may result during installation of any resultant pile structure.

The overall geothermal pile structure resulting through use of the first aspect of the invention is overall more structurally robust than a comparable geothermal energy structure resulting from the piles as depicted in, e.g., FIG. 2. As alluded to above, the first part of the joint of the first aspect of the invention permits fluid conduits/pipes that are embedded in the material of each pile segment to pass to an exterior of the pile segment (via the apertures) and to connect to correspondent fluid conduits/pipes in an adjacent pile segment. As a result of such an arrangement a higher density of pre-cast material is achieved within the resultant geothermal pile structure formed by use of the first aspect of the invention compared to a geothermal pile structure resulting from the use of the piles as depicted in FIG. 2. This is because, with reference to the piles as depicted in, e.g., FIG. 2, the need for a large hollow bore at the centre of each pile segment 41a-41c can be avoided through use of the present invention. The apertures permit for fluid conduits/pipes embedded within the material of the pile to pass through the first part of the joint of the first aspect and thereby a structurally more robust geothermal pile segment and structure can be achieved.

The volume defined by the end plate and the peripheral wall is, as used herein, the volume defined by the maximum cross-sectional area of the cap when viewed from the end plate multiplied by the (maximum) height of the peripheral wall as measured perpendicular to the end plate. That is, it can be considered as the volume footprint defined by the end plate and the peripheral wall, or the regularly shaped volume that would be occupied by the cap (as defined by the end plate and peripheral wall) when ignoring for any irregularities or inconsistencies (e.g. recesses or openings) within the peripheral wall and/or end plate.

Thus, it will be appreciated that each of the apertures are provided within the volume of the cap (i.e. as defined by the end plate and the peripheral wall) since they are recessed within the peripheral wall and thereby recessed within the volume of the cap. The recess has no impact on the volume of the cap as defined herein.

The inside of the cap may be considered as a first side of the cap which is configured to come into engagement with the pre-cast pile segment once the first part of pile joint of the first aspect is fitted thereto/integrated therewith. It is thus the side that contacts the material (typically and optionally concrete) of the pile segment. The outside of the cap may be considered as a second side of the cap that is opposed to the first side and is thus the side of the cap that faces away from the pre-cast pile segment when the first part of the pile joint of the first aspect is integrated therewith. That is, the outside/second side of the cap is that part of the cap that is exposed to an exterior of the pile segment when the cap is integrated thereto and/or that is configured to come into engagement with a second part of the joint on a counterpart pre-cast pile segment (when formed as part of a joint).

As alluded to above, the first part of the pile joint is configured to be joined to a second, correspondent part of a pile joint in order that two adjacent geothermal pile segments can be joined together to form (at least part of) a geothermal pile structure. The second part of the pile joint may, in effect, be identical to the first part of the pile joint. However, it will be arranged on a separate pile segment such that it can suitably join with the first part and such that its apertures can suitably communicate with respective apertures of the first part to permit fluid communication therebetween (e.g. as provided by connected fluid conduits). This arrangement may merely require a suitable orientation of the second part relative to the first part such that suitable engagement between the two parts is enabled in order to establish the joint.

As above, the apertures of the first aspect of the invention are recessed within the peripheral wall and as such each aperture is provided within a recess in the peripheral wall. Each aperture may be provided in its own respective recess within the peripheral wall or the same recess. The recess(es) permit the aperture to be exposed to both the inside and the outside of cap whilst still being maintained within the overall volume defined by the cap. Each recess may be in the form of an indent formed in the peripheral wall. The recess(es) in the peripheral wall may extend from the end plate, optionally perpendicularly with respect to the end plate, along all or part of the height of the peripheral wall.

Each peripheral wall recess may be configured to receive and retain a cover plate. Alternatively, each peripheral wall recess may be configured to receive a portion of a cover plate with the other portion of the cover plate being configured to be received and retained in a corresponding peripheral wall recess on a corresponding second part of the pile joint. Each cover plate, when received and retained in a respective recess (either wholly or partly), may cover the recess such that a channel defined by the peripheral wall and cover plate is formed between the end plate and the aperture. In that way, access to the apertures is still maintained from the outside of the cap (e.g. such that a fluid connection between adjacent segments can be established) whilst protection of the apertures and any fluid pipes/conduits passing therethrough is enhanced by the cover plate in a direction normal to the peripheral wall.

The first part of the pile joint may be configured to have the cover plate fastened or attached within a respective peripheral wall recess in order to retain it therein.

Retention of the cover plate in the recess(es) may be configured to be achieved by attachment means, for instance bolts, pins, rivets etc. Accordingly, the cover plate may comprise one or more holes (e.g. bolt holes, rivet holes, pin holes) suitable for receiving the attachment means therethrough and which enable the fastening/attachment of the cover plate to the first part of the pile joint.

Alternatively, the first part of the pile joint may be configured such that interaction between the cover plate and the recess in itself may be sufficient to retain the cover plate (e.g. through an interference fit or through use of appropriate grooves and slots).

The cap of the first part of the first aspect may have a square cross-section when viewed from the end plate. Typically, pre-cast driven concrete piles and pile segments are formed themselves with a square cross section. Therefore, in scenarios where the cap also has a square cross section it can be readily fitted to/integrated as part of pre-cast driven pile segments with few changes required to the already available manufacturing processes for said pile segments (other than those changes that are required—e.g. the introduction of fluid conduits within the pile segments—to make the pile segments suitable for use in a geothermal pile structures).

Alternatively, the cap of the first aspect may have any other alternative shape in cross-section when viewed from the end plate, with the shape being determined by the cross section of the pre-cast pile segments to which the first part is to be fitted/integrated with.

The peripheral wall may extend normally (i.e. perpendicularly) or substantially normally (i.e. substantially perpendicularly) from the end plate.

As will be noted from the above discussion, the pre-cast pile segment to which the first part of the joint is configured to be fitted may be formed/cast from concrete.

The first part of the joint of the first aspect of the invention may be formed as a modification to a first part of a Leimet ABB PLUS joint as has been discussed above. As such, the first part of the joint of the first aspect may be a first part of a Leimet ABB PLUS joint with the necessary modifications made thereto such that it is in accordance with the first aspect of the invention.

The first part of the joint of the first aspect of the invention may comprise one or more reinforcement bars extending from the end plate in an inside direction/through the inside of the cap. That is, the reinforcement bars may extend from an inside surface of the end plate. The reinforcement bars (or “rebars”) may be configured to be embedded within the material (e.g. concrete) of a pile segment when the first part of the joint is attached thereto/integrated therewith. The reinforcement bars may reinforce the resultant pile segment, improving its structural robustness. In addition, the reinforcement bars may serve to improve adherence of the first part of the joint to the pile segment.

The first part of the joint of the first aspect of the invention may comprise one or more protrusions (also termed locking dowels) extending from the end plate on the outside of the cap (i.e. an outside surface of the end plate). The protrusion(s) on the first part may be configured to be received within one or more corresponding indentations provided on an end plate (i.e. an outside surface of the end plate) of a second part of the joint when the joint is joined together. The first part may comprise any number of protrusions, for instance 1, 2, 3, 4, etc.

The first part of the joint of the first aspect of the invention may comprise one or more indentations (also termed locking blocks) situated on the end plate on the outside of the cap (i.e. an outside surface of the end plate). The one or more indentations on the first part may be configured to receive one or more corresponding protrusions provided on an end plate (i.e. an outside surface of an end plate) of a second part of the joint when the joint is joined together. The first part may comprise any number of indentations, for instance 1, 2, 3, 4, etc.

A channel may be provided in (i.e. through) each protrusion and/or each indentation. The channel in each protrusion and/or each indentation may be configured to receive a locking pin.

The channel in each protrusion may be configured to align with a channel through an indentation provided on an end plate of a second part of the joint when the protrusion is received within the indentation of the second part. The channel through each indentation may be configured to align with a channel in a protrusion provided on an end plate of a second part of the joint when the indentation receives the protrusion. These aligned configurations may allow for a locking pin to be inserted through the channels to lock the first part of the pile joint to a second part of the pile joint.

The first part of the pile joint of the first aspect must comprise at least two apertures such that an appropriate fluid loop can be established which is necessary for geothermal pile structures. However, further conduits may be present dependent on the number and the nature of fluid loops to be established within the resultant geothermal pile structure in which the joint is to be used. This will be dependent on the number of fluid conduits embedded in the pile segment to which the first part of the joint is to be fitted. For instance, the first part of the joint of the first aspect may comprise 2, 3, 4, 5, 6, 7, 8, 9, 10, etc. apertures.

The first part of the joint may be formed from steel. The first part of the joint may be considered a first part of a steel box joint.

The first part of the pile joint of the first aspect may be configured to be welded to a second part of the pile joint in order to form the joint.

In a second aspect of the invention, there is provided a kit, the kit comprising a first part of a pile joint in accordance with the first aspect of the invention and at least two fluid conduits, each fluid conduit being configured to pass through a respective aperture.

The kit of the second aspect is advantageous since it may be incorporated into an otherwise largely typical casting process for pre-cast driven piles (i.e. a standard, prior art casting process for manufacturing non-geothermal pile segments) such that suitable geothermal pre-cast driven pile segments can be obtained.

The first part of the pile joint comprised as part of the second aspect of the invention may include any optional features of the first aspect of the invention as set out above.

The fluid conduits may be fluid pipes. The fluid conduits may be formed from a flexible material, e.g. an elastomeric material such as rubber.

The fluid conduits may be configured to transport water and/or water mixed with anti-freeze. In either scenario, the fluid conduits may be termed water pipes/conduits.

Each fluid conduit may be configured to be embedded within a pile segment and to pass through an aperture of the first part of the pile joint once the first part of the pile joint is integrated with/fitted to an axial end of the pile segment. Each fluid conduit may additionally be configured to pass through an aperture of another first part and/or a second part of a pile joint situated at an opposed axial end of the pile segment once integrated with/fitted to the pile segment. This additional first part and/or second part may be in accordance with the first aspect of the invention as described above, optionally including any optional features thereof. In this way, the fluid conduits permit the necessary fluid loop to be established through and between adjacent pile segments such that a geothermal pile structure may be formed.

The fluid conduits may be configured to extend through a plurality of adjacent pile segments. That is, each conduit may be of sufficient length such that it is capable of passing through a first pile segment, through an aperture in the first part of the pile joint of the first aspect, through an aperture in a corresponding second part of a pile joint fitted to an adjacent pile segment, through a second pile segment, and (optionally) etc.

Alternatively, the fluid conduits may only have a length that permits them to be embedded within and extend through a single pile segment. In such a scenario, each end of the conduits may protrude from an aperture of respective parts of a pile joint in accordance with the first aspect of the invention provided at opposed axial ends of the pile segment. The ends of the conduit may protrude from the apertures, but the ends may still be situated within the volume defined by the end plate and peripheral wall (i.e. the end of each conduit may be positioned within the same recess as the aperture). In that way, a shielding protection is provided to the end of the conduits and any connection made thereat (more on this below) by the cap.

Where each end of a fluid conduit protrudes from an aperture but is maintained within the volume defined by the end plate and peripheral wall of the given cap, a connection with an end of a fluid conduit in an adjacent pile segment would be required in order to establish a fluid loop between adjacent pile segments. This connection may be configured to be established directly (i.e. by direct connection of conduits in adjacent pile segments) or may be configured to be established indirectly via a suitable connector. In a scenario where an indirect connection is configured to be established with the end of each fluid conduit, the kit of the second aspect may comprise one or more of: a hose clip, a pipe nozzle, a flexible (e.g. rubber) hose, compression sleeve fitting components, other water pipe coupling components, etc. Suitable components which may be used to provide the indirect connection are manufactured and sold by Uponor™, Rehau™ and/or GF™ Piping Systems. Advantageously, the end of each fluid conduit is configured to connect with a connector that is either wholly or partly flexible. Flexible connectors are able to withstand and resist the forces and damage that can result from the installation and use of the pile segments to which the first of the joint is configured to be attached.

In a third aspect of the invention, there is provided a kit comprising: a first part of a pile joint in accordance with the first aspect of the invention (optionally in accordance with any optional form thereof), wherein the, or each, peripheral wall recess is configured to receive and retain a cover plate or a portion of a cover plate; and at least one cover plate, each cover plate being configured to be, wholly or partly, received within and retained in a respective peripheral wall recess so as to cover the recess such that a channel defined by the peripheral wall and the cover plate is formed between the aperture and end plate.

The cover plate of the third aspect of the invention may be in accordance with the cover plate discussed above in connection with the first aspect of the invention.

The cover plate may be configured to be fastened or attached within a respective peripheral wall recess in order to retain it therein.

Retention of the cover plate in the recess(es) may be achieved by attachment means, for instance bolts, pins, rivets etc. Accordingly, the cover plate and the first part of the pile joint may each comprise one or more holes (e.g. bolt holes, rivet holes, pin holes) that are suitable for receiving the attachment means therethrough. Each hole in the cover plate may be arranged such that it is alignable with a respective hole in the first part of the pile joint when the cover plate is received in the peripheral wall recess. These holes may thus be considered to form an aligned pair. An attachment means may be inserted through each pair of aligned holes in the cover plate and the first of the pile joint to enable the fastening/attachment of the cover plate to the first part of the pile joint.

Alternatively, the interaction between the cover plate and the recess(es) in itself may be sufficient to retain the cover plate (e.g. through an interference fit or through use of appropriate grooves and slots).

The kit of the third aspect may comprise a plurality of cover plates, each cover plate being configured to be received within and retained in a different, respective peripheral wall recess so as to cover said recess such that a channel defined by the peripheral wall and the cover plate is formed between the aperture and end plate.

In a fourth aspect of the invention, there is provided a pile joint for joining geothermal pre-cast pile segments, the joint comprising a first part of a pile joint according to the first aspect of the invention and a second part of a pile joint for joining geothermal pre-cast pile segments, the second part comprising: a cap having an end plate and a peripheral wall extending from a periphery of the end plate, the end plate and peripheral wall defining a volume; and at least two apertures passing through the cap, wherein each aperture provides a passage from inside (i.e. a first side) of the cap to outside (i.e. a second opposed side) of the cap; and wherein each aperture is provided within a recess in the peripheral wall such that each aperture is thereby recessed within the volume defined by the end plate and the peripheral wall.

The first part of the pile joint of the fourth aspect of the invention may comprise any optional features of the first part of the pile joint of the first aspect as described above.

The second part of the pile joint of the fourth aspect may, as discussed above, correspond to the first part of pile joint of the first aspect, optionally including any optional features thereof (with the necessary modifications/changes made thereto such that it can suitably interact and function with the first part of the pile joint). As such, the joint of the fourth aspect may in effect comprise two first parts in accordance with the first aspect of the invention, wherein the first parts are configured to be joined together. This joined configuration may involve orientating each first part in a specific orientation relative to one another to allow a suitable connection therebetween (e.g. such that their respective protrusions and recesses can interact with one another).

It will be understood that the first part and the second part of the pile joint are configured to permit two pile segments to be joined to one another as part of a geothermal pile structure whilst permitting fluid connections therebetween (via the recessed apertures) that is sufficient to establish a fluid loop for geothermal energy purposes.

The pile joint of the fourth aspect may comprise at least two connectors. Each of the at least two connectors may be configured to connect to an end of a fluid conduit associated with the first part of the pile joint and protruding from an aperture thereof with an end of a fluid conduit associated with the second part of the pile joint and protruding from an aperture thereof so as to provide fluid communication therebetween. The connectors may comprise one or more of: a hose clip, a pipe nozzle, a flexible (e.g. rubber) hose, compression sleeve fitting components, other water pipe coupling components, etc. Components of the connector may be components that are manufactured and sold by Uponor™, Rehau™ and/or GF™ Piping Systems. The connectors may be either wholly or partly flexible.

The pile joint of the fourth aspect may further comprise one or a plurality of cover plates. Each cover plate may be configured to be inserted into a single recess on either the first or the second part of the joint and to be retained therein. Alternatively, each cover plate may be configured to be inserted into a recess on the first part of the pile joint and an aligned recess on the second part of the pile joint when the joint is joined together.

Retention of the cover plate in the recess(es) may be achieved by attachment means, for instance bolts, pins, etc. Accordingly, the cover plate, the first part of the pile joint and/or the second part of the pile joint may each comprise one or more holes (e.g. bolt holes, rivet holes, pin holes) that are suitable for receiving the attachment means therethrough. Each hole in the cover plate may be arranged such that it is alignable with a respective hole in the first part of the pile joint or the second part of the pile joint when the cover plate is received in the peripheral wall recess(es). These holes may thus be considered to form an aligned pair. An attachment means may be inserted through each pair of aligned holes in the cover plate and the first of the pile joint or the second part of the pile joint to enable the fastening/attachment of the cover plate to the first part of the pile joint or the second part of the pile joint.

Alternatively, the interaction between the cover plate and the recess(es) in itself may be sufficient to retain the cover plate (e.g. through an interference fit or through use of appropriate grooves and slots).

The cover plates, once received in the recess(es), may cover the recess(es) such that a channel defined by the peripheral wall(s) and cover plate is formed between the aperture and end plate (in a scenario where the cover plate is inserted in a single recess) or between an aperture of the first part of the pile joint and a corresponding aperture of the second part of the pile joint (in a scenario where the cover plate is inserted into a recess on the first part of the pile joint and an aligned recess on the second part of the pile joint when the joint is joined together). In that way, a fluid connection can still be established/maintained between adjacent pile segments via the aperture(s) whilst enhanced protection of the aperture(s) and any fluid connection thereat is provided for by the cover plate in a direction that is normal/perpendicular to the peripheral wall.

The joint of the fourth aspect may comprise one or more locking pins that are each configured to be inserted through channels provided in protrusions and indentations of the first and second parts of the pile joints.

The, or each, recess on the first part of the pile joint of the fourth aspect may be configured to align with a corresponding recess on the second part of the pile joint when the first part and the second part of the pile joint are joined together. This may define a passage that permits a fluid conduit associated with the first part of the pile joint and protruding from an aperture thereof and a fluid conduit associated with a second part of the pile joint and protruding from an aperture thereof to be housed and joined therein.

In a fifth aspect of the invention, there is provided a geothermal pre-cast driven pile segment having at least two fluid conduits embedded therein; and a first part of a pile joint in accordance with the first aspect of the invention fitted at/integrated with an axial end of the pre-cast driven pile segment, wherein an end of each fluid conduit protrudes through a respective aperture of the first part of the pile joint.

The geothermal pre-cast driven pile segment of the fifth aspect of the invention may comprise a further first part of a pile joint or a second part of a pile joint (either one of which may be in accordance/correspond to the first aspect of the invention) fitted at/integrated with the other axial end of the pre-cast driven pile segment. An end of each fluid conduit may protrude through a respective aperture of the further first part/second part of the pile joint.

The first part of the pile joint, further first part of the pile joint and/or second part of the pile joint of the fifth aspect of the invention may avail from any optional features of the first part of the pile joint of the first aspect of the invention.

The pre-cast driven pile segment of the fifth aspect may be cast (primarily) from concrete. The pre-cast driven pile segment may be square in cross-section when viewed from an axial end thereof or may have any other suitable cross-sectional shape (e.g. circular).

In a sixth aspect of the invention, there is provided a geothermal pile structure, the geothermal pile structure comprising: a first pre-cast driven pile segment having at least two fluid conduits embedded therein; and a second pre-cast driven pile segment having at least two fluid conduits embedded therein, wherein the first pre-cast pile segment and the second pre-cast pile segment are joined together with a pile joint in accordance with the fourth aspect of the invention (optionally including any optional features thereof), and wherein each fluid conduit in the first pre-cast pile segment is connected to a respective fluid conduit in the second pre-cast pile segment to establish a fluid connection therebetween via a respective aperture in the first part of the pile joint and a respective aperture in the second part of the pile joint.

The first and/or second pre-cast driven pile segments are optionally cast (primarily) from concrete. The first and/or second pre-cast driven pile segments optionally are square in cross-section when viewed from an axial end thereof. Alternatively, the first and/or second pre-cast pile segments may have any other shape in cross-section when viewed from an axial end thereof, e.g. circular.

In a seventh aspect of the invention, there is a method of manufacturing a first part of a pile joint for joining pre-cast driven geothermal pile segments, the method comprising: forming a cap having an end plate and a peripheral wall extending from a periphery of the end plate, the end plate and peripheral wall defining a volume, wherein at least one recess is formed in the peripheral wall; providing at least two apertures in the at least one recess such that the apertures are recessed within a volume defined by the end plate and peripheral wall, wherein the at least two apertures each provide a passage from a first side/inside of the cap to a second opposed side/outside of the cap.

The seventh aspect of the invention may be used to manufacture a first part of a pile joint in accordance with the first aspect of the invention, optionally inclusive of any optional features thereof.

In an eighth aspect of the invention, there is provided a method of assembling a geothermal pile structure in accordance with the sixth aspect of the invention, optionally including any optional features thereof.

In a ninth aspect of the invention, there is provided a method of manufacturing a geothermal pre-cast driven pile segment in accordance with the fifth aspect of the invention. The method may comprise providing the first part of the pile joint of the first aspect of the invention (optionally in accordance with any optional form thereof), positioning at least two fluid conduits such that an end of each conduit passes through a respective aperture in the first part of the pile joint, and pouring concrete so as to fill the interior of the first part of the pile joint, to embed the fluid conduits within the concrete and to thereby form the geothermal pre-cast driven pile segment.

The method of the ninth aspect may result in any optional form of the pre-cast driven pile segment of the fifth aspect.

In a tenth aspect, there is provided a method of harvesting geothermal energy, the method comprising circulating fluid through the fluid conduits of a geothermal pile structure in accordance with the sixth aspect of the invention (optionally in accordance with any optional form thereof) such that thermal exchange is enabled between the fluid and surrounding ground within which the geothermal pile structure is installed.

In an eleventh aspect, the invention provides a first part of a pile joint for joining pre-cast driven geothermal pile segments (i.e. pile segments configured for harvesting geothermal energy), the first part comprising: a cap having an end plate and a peripheral wall extending from a periphery of the end plate, the end plate and peripheral wall defining a volume; and at least two apertures passing through the cap, wherein each aperture provides a passage from inside (a first side) of the cap to outside (i.e. a second opposed side) of the cap; and wherein each aperture is recessed within the volume defined by the end plate and the peripheral wall.

Optionally, the apertures are recessed within the end plate. That is to say, each aperture is provided within a recess within the end plate. Each aperture may be provided in its own respective recess within the end plate. However, optionally each aperture may be provided within the same, single recess in the end plate. This single recess may be provided centrally within the end plate. The/each recess optionally may take the form of a bore extending from the end plate into the volume of the cap. Each aperture may be provided within a sidewall of the/each bore. The recess(es) permit the aperture to be exposed to both the inside and the outside of cap whilst still being maintained within the overall volume defined by the cap.

A method of forming the first part of a pile joint of the eleventh aspect, a joint comprising the first part of a pile joint of the eleventh aspect and a correspondent second part of a pile joint, a geothermal pre-cast driven pile segment comprising the first part of the joint of the first aspect and a geothermal pile structure formed using a joint comprising the first part of the pile joint of the eleventh aspect are also provided.

Certain embodiments of the invention will now be described, by way of example only, and with reference to the accompanying drawings, in which:

FIGS. 1A-1C depict a prior art joint for joining pre-cast driven piles;

FIG. 2 depicts a disassembled geothermal pile structure known from the prior art;

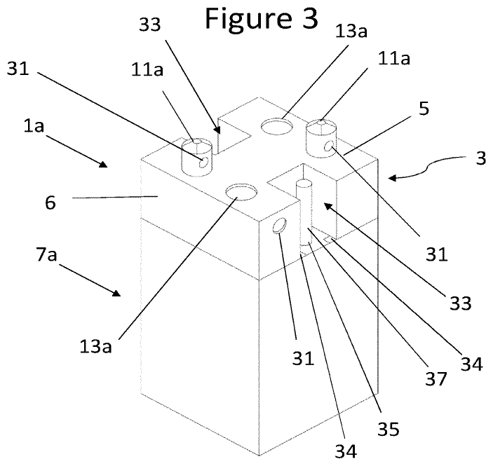

FIG. 3 is a perspective view of a first part of a pile joint in accordance with an embodiment of the invention integrated as part of a pre-cast driven pile segment;

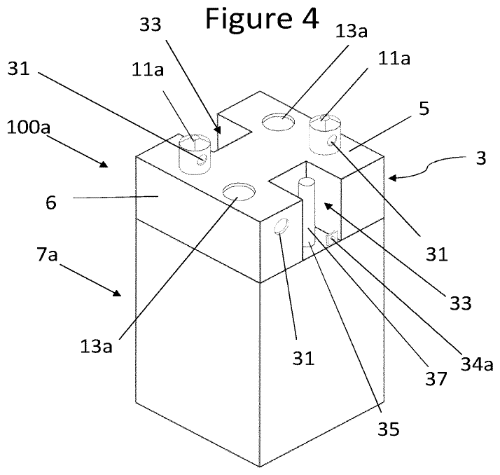

FIG. 4 is a perspective view of a first part of a pile joint in accordance with another embodiment of the invention integrated as part of a pre-cast driven pile segment;

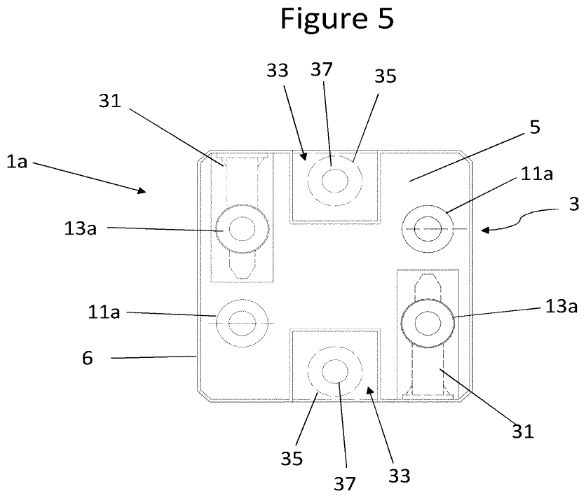

FIG. 5 is a plan view of the first part of the pile joint of FIG. 3 as viewed from its outside;

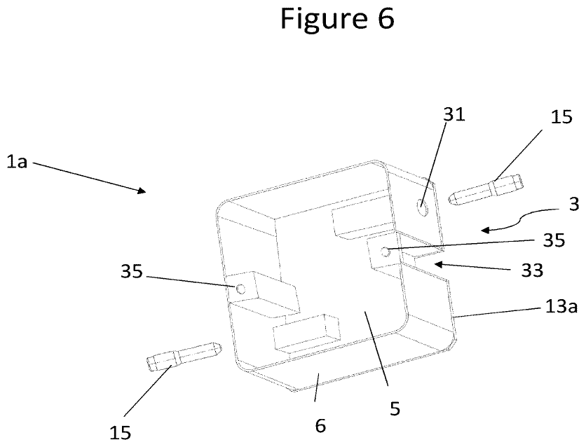

FIG. 6 is a perspective view of the first part of the pile joint of FIG. 3 as viewed from its inside;

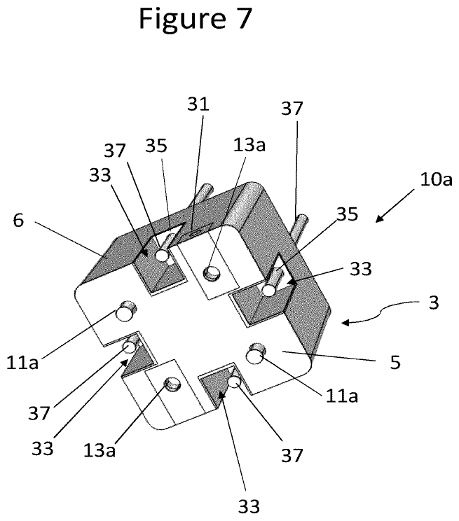

FIG. 7 is a perspective view of a different embodiment of a first part of a pile joint;

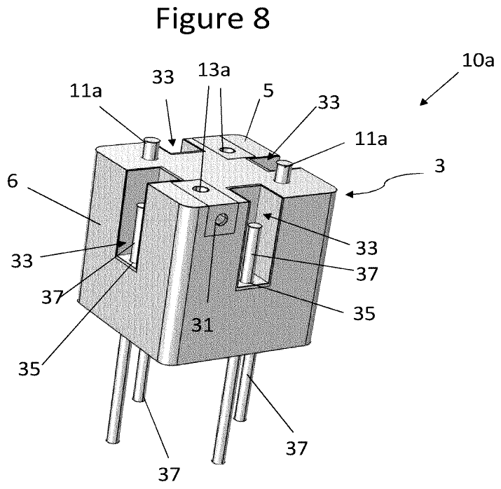

FIG. 8 is a further perspective view of the first part of the pile joint of FIG. 7;

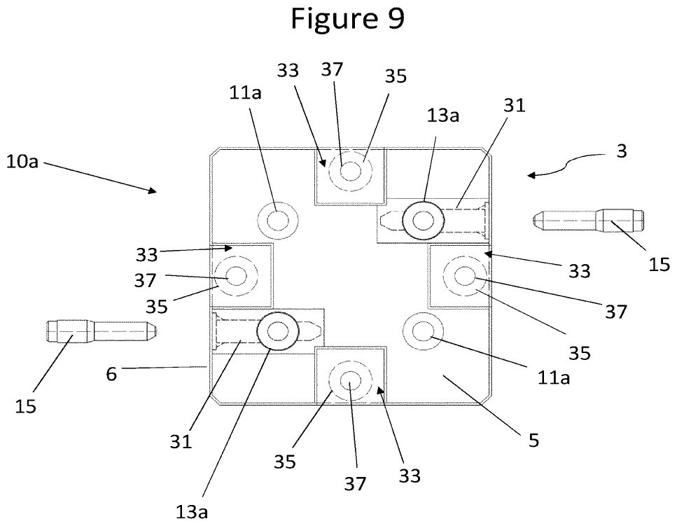

FIG. 9 is a plan view of the first part of the pile joint of FIG. 7 as viewed from its outside;

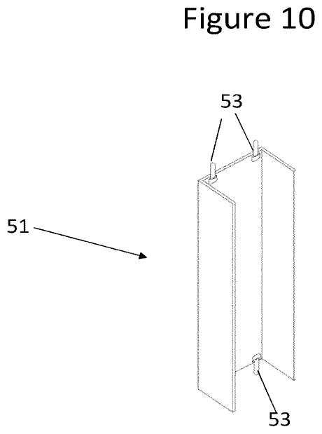

FIG. 10 is a perspective view of a cover plate;

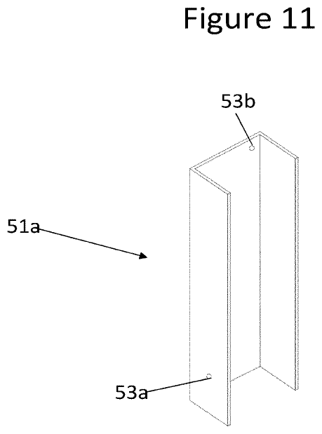

FIG. 11 is a perspective view of an alternative cover plate;

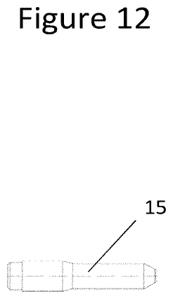

FIG. 12 is a side view of a locking pin for use as part of a pile joint;

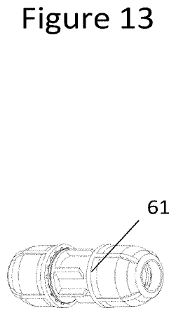

FIG. 13 is a perspective view of a connector for use as part of a pile joint;

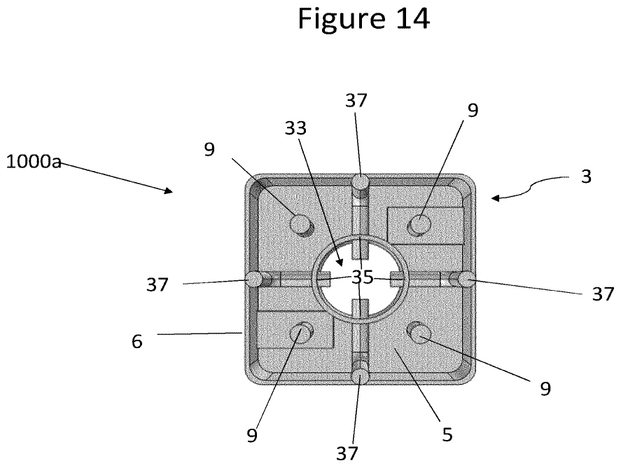

FIG. 14 is a plan view of a first part of a pile joint as viewed from its inside and which does not fall within the scope of the claims of this application as filed;

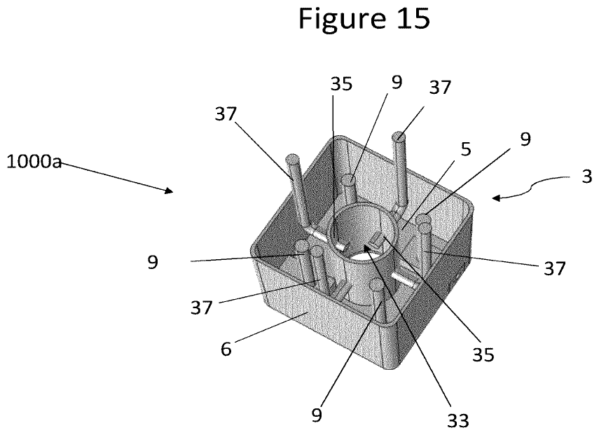

FIG. 15 is a perspective view of the first part of the pile joint of FIG. 14 as viewed from its inside; and

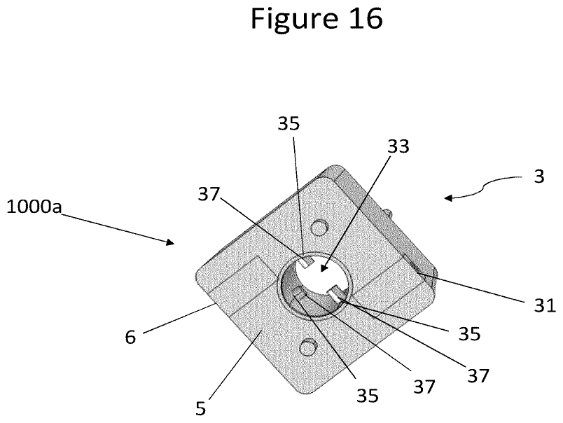

FIG. 16 is a perspective view of the first part of the pile joint of FIG. 14 as viewed from its outside.

FIGS. 3, 5 and 6 show a first part 1a of a pile joint. Specifically, FIG. 3 shows the first part 1a of the pile joint as integrated at an axial end of a pre-cast pile segment 7a, whilst FIGS. 5 and 6 show the first part 1a of the pile joint in absence of a pre-cast pile segment 7a. As will be appreciated from the above and below description, the first part 1a of the pile joint as depicted in FIG. 3 is formed as a modification to a first part of a Leimet ABB PLUS joint discussed previously with reference to FIGS. 1A-1C, and thus it shares many features correspondent to the first part of the Leimet ABB PLUS joint already described. These correspondent features have thus been denoted with shared reference numerals.

The first part 1a comprises a cap 3 having an end plate 5 with a peripheral wall 6 extending from a periphery thereof. When viewed from the end plate 5 (see e.g. FIG. 5), the cap 3 can be seen to have a square cross-section that matches that of the driven pile segment 7a.

The interior of the cap 3 defined between the end plate 5 and peripheral wall 6 is filled with the concrete of the pile 7a during the casting of the pile (as can be seen in FIG. 3). As such, the inside surface of the end plate 5 mates to an axial end surface of the driven pile segment 7a whilst the peripheral wall 6 extends along an outer surface of the driven pile 7a.

Two protrusions (otherwise termed locking dowels) 11a and two indentations (otherwise termed locking blocks) 13a are provided on the end plate 5 of the first part 1a on the outside of the cap 3. The two protrusions 11a on the first part 1a are configured to be received within the two indentations on a corresponding second part of the joint. Similarly, the two indentations 13a on the first part 1a are configured to receive two protrusions on the second part of the joint when the joint is joined together.

A channel 31 is provided in each protrusion 11a and in each indentation 13a. The channel 31 in each protrusion 11a, when each protrusion 11a is inserted in a corresponding indentation on the second part of the joint, is configured to align with a channel in the corresponding indentation. Similarly, the channel 31 in each indentation 13a, when the indentation 13a receives a corresponding protrusion on the second part, is configured to align with a channel in the corresponding protrusion. The channels 31 of the protrusions 11a and the indentations 13a once aligned with the channels of the indentations and protrusions on the second part of the joint, respectively, allow for the insertion of a locking pin 15 (one locking pin 15 for each coupled protrusion and indentation). A more detailed view of the locking pin can be seen in FIG. 12. The insertion of the locking pin 15 locks each protrusion 11a/indentation 13a to a corresponding indentation/protrusion on the second part and thereby locks the first part 1a to the second part of the joint. Thus, the pile segment 7a having the first part 1a of the joint can be locked and joined to a pile segment that has the second part of the joint fixed thereto.

Extending from the end plate 5 and along the peripheral wall 6 of the first part 1a are two recesses 33 situated on opposed sides of the peripheral wall 6 of the cap 3. The recesses 33 are comprised within the volume of the cap 5 defined by the end plate 5 and peripheral wall 6.

Situated within each recess 33 is an aperture 35. Each aperture provides a passage from an inside of the cap 5 to an outside of the cap 5. Passing through each aperture 35 is a fluid conduit 37 in the form of a water pipe 37. Each water pipe 37 is embedded within and passes through the concrete of the pre-cast driven pile 7a and then extends through a respective aperture 35 such that the end of each of water pipe 37 is situated on the outside of the cap 3 and positioned within a respective recess 37.

The apertures 35 permit the two water pipes 37 to protrude from the pre-cast driven pile 7a and in that way the water pipes 37 can be connected to corresponding water pipes protruding from a second part of a pile joint fixed to a further pre-cast pile segment when the joint is formed. As such, a fluid loop can be established between the first pre-cast pile segment 7a and a further second pre-cast pile segment when the two are joined together by means of the joint formed from the first part 1a and the second part (not shown).

The recesses 33 in which each aperture 35 are provided maintain the ends of the water pipes 37 within the volume of the cap 3 as defined by the end plate 5 and the peripheral wall 6. In that way, when the pre-cast pile segment 7a is being installed as part of a geothermal pile structure by being driven into the ground, the portion of the water pipe 37 within the first part 1a of the joint and any water connection established thereat is partly shielded and thus given protection from the harsh and attritional forces involved in the installation process. Protection is also provided once the pile segments are installed. As such, a reliable watertight connection between adjacent pile segments can be achieved. The volume provided by the recesses 33 about the apertures 35 also provides a working volume for an operative to provide installation operations related to the fluid conduit 37 connection, as required.

Provided within each recess 33 are a pair of openings 34 spaced at opposed sides of each recess 33. The function of these openings 34 will be described in greater detail below with reference to FIG. 10.

FIG. 4 shows an alternative embodiment of a first part 100a of a pile joint. The first part 100a of the pile joint depicted in FIG. 4 is largely identical to the first part 1a of the pile joint depicted in FIGS. 3, 5 and 6. As such, like features in the embodiment of FIG. 4 have been denoted with like reference numbers to those used in FIGS. 3, 5 and 6, and a detailed description of those features will not be repeated herein.

The first part 100a of the pile joint depicted in FIG. 4 differs from that depicted in FIGS. 3, 5 and 6 in that it is absent a pair of openings 34 provided within each recess 33. Instead, a rivet hole 34a provided on a flange extending upwardly from a lowermost portion of each recess 33 is provided. The function of the rivet hole 34a will be described in greater detail below with reference to FIGS. 10 and 11.

FIGS. 7 to 9 show an alternative first part of a pile joint 10a for joining pre-cast driven pile segments. The first part of the pile joint 10a of FIGS. 7 to 9 is largely correspondent to the first part of the pile joint 1a described above in relation to FIGS. 3, 5 and 6. Accordingly, correspondent features have thus been denoted with shared reference numerals and a detailed description of the correspondent features will not be repeated again here.

Where the first part 10a of the pile joint of FIGS. 7 to 9 differs from that described above in relation to FIGS. 3, 5 and 6 is that four recesses 33 are provided in the peripheral wall 6. Each recess 33 again comprises an aperture 35 resulting in four apertures 35 being present in the first part of the pile joint 10a. As such, and as shown, four water pipes 37 are permitted to pass from being embedded in a pre-cast driven pile segment and through the apertures 35. In that way two fluid loops can be established in a geothermal pile structure comprising use of the first part 10a of the joint and a corresponding second part of the joint since four separate fluid connections can be established between adjacent pile segments.

FIG. 10 depicts a cover plate 51 configured to be used as part of a pile joint comprising either of the first part 1a or the first part 10a of the pile joint described above with reference to FIGS. 3, 5 and 6 or FIGS. 7 to 9. The cover plate 51 is configured to be received with a given recess 33 on the first part 1a, 10a of the joint and a corresponding and aligned recess on a second part of the joint once the joint has been joined together. The cover plate 51 is retained within the recesses 33 on the first part 1a, 10a and the second part through engagement of the pins 53 with the first part 1a, 10a and second part once it has been inserted therein. Openings 34 for receipt of the pins 53 to provide retention of the cover plate 51 are shown in FIG. 3.

FIG. 11 depicts an alternative cover plate 51a configured to be used as part of a pile joint comprising the first part 100a described above with reference to FIG. 4. The cover plate 51a differs from the cover plate 51 depicted in FIG. 10 in that it does not comprise pins 53, but instead comprises a first rivet hole 53a positioned at a first end of the cover plate 51a and a second rivet hole 53b positioned at a second end of the cover plate 51a. The first rivet hole 53a is arranged so as to align with the rivet hole 34a provided on the first part 100a of the pile joint once the cover plate 51a has been inserted within the recess 33. The second rivet hole 53b is similarly arranged so as to align with a rivet hole provided on a flange within a recess of a second part of the joint once inserted therein. Once the rivet holes 34a, 53a have been aligned a rivet can be inserted through both rivet holes 34a, 53a so as to secure the cover plate 51a to the first part 100a of the joint. The cover plate 51a can be similarly secured to a second part of the joint via the rivet hole 53b and its counterpart rivet hole on the second part of the joint.

The cover plates 51, 51a, once inserted within a given recess 33 on the first part 1a, 10a, 100a, and a corresponding recess on the second part of the joint, each define, in combination with the peripheral walls 6 of the first part 1a, 10a, 100a and second part, a shielded channel between a given aperture 35 on the first part 1a, 10a, 100a of the joint and a corresponding aperture on the second part of the joint. Within this shielded channel, a given water pipe 37 associated with the first part 1a, 10a, 100a of the joint can connect to a water pipe associated with the second part of the joint to establish a fluid connection therebetween. The apertures 35, water pipes 37 and any connection therebetween are provided with a mechanical shielding by the cover plate 51, 51a once it is inserted, which prevents damage to these components during the installation of the pile segments to which they are attached (and also once installed in place).

FIG. 13 shows an exemplary connector 61 that may be used to connect a water pipe 37 protruding from an aperture 35 of the first part 1a, 10a, 100a of a pile joint with a corresponding water pipe 37 protruding from an aperture of a second part of the joint. The connector 61 depicted is a pipe coupler iJoint, product code number 158400002, available for sale from GF™ Piping Systems.

FIGS. 14 to 16 show an alternative first part 1000a of a pile joint for joining pre-cast driven pile segments. The first part 1000a of the pile joint does not fall within the scope of the claims of this application as filed. The first part 1000a of the pile joint of FIGS. 14 to 16 shares many of the same features as the first part 1a of the pile joint described above in relation to FIGS. 3, 5 and 6. These features have thus been denoted with the same reference numerals in FIGS. 14 to 16 and will not be described again in detail here.

Where the first part 1000a of the pile joint differs to the first part 1a is that the recess 33 in which the apertures 35 are provided is situated solely within the end plate 5 of the first part 1000a of the joint and is not provided within the peripheral wall 6.

The recess 33 of first part 1000a of the pile joint is in the form of a cylindrical bore 33 extending into the volume of the cap 3 as defined by the end plate 5 and the peripheral wall 6. Four apertures 35 are defined within the sidewall of the cylindrical bore 33 such that they are exposed to both an inside and an outside of the cap 3. As shown, each aperture 35 permits a water pipe 37 to extend therethrough. As such, four water pipes 37 embedded within a first pre-cast pile segment (not shown) can be permitted to connect to four correspondent water pipes in a second pre-cast pile segment by virtue of the apertures 35.

The recess 33 ensures that the apertures 35, the water pipes 37 protruding therefrom and any connection made between the water pipes are housed centrally within the first part 1000a and/or a correspondent recess provided in a second part of the joint and thereby shielded protection is provided to these components by virtue of the cap 3 of the first part 1000a.

The first part 1000a of the pile joint also comprises four reinforcement bars 9 extending from the inside surface of the end plate 5 of the cap 3. When the cap 3 is attached as part of a pile segment, the four reinforcement bars 9 would be embedded within the concrete of the pile segment to provide reinforcement thereto and to hold the cap 3 in place on the end of the pile segment.

1. A first part of a pile joint for joining pre-cast geothermal pile segments, the first part comprising:
a cap having an end plate and a peripheral wall extending from a periphery of the end plate, the end plate and peripheral wall defining a volume; and
at least two apertures passing through the cap, wherein each aperture provides a passage from an inside of the cap to an outside of the cap;
and
wherein each aperture is provided within a recess in the peripheral wall such that each aperture is thereby recessed within the volume defined by the end plate and the peripheral wall.

2. The first part of a pile joint of claim 1, wherein each aperture is provided within a different respective recess in the peripheral wall.

3. The first part of a pile joint of claim 1, comprising one or more reinforcement bars extending from an inside surface of the end plate, wherein the reinforcement bars are configured to be embedded within the material of a pile segment when the first part of the pile joint is fitted thereto.

4. The first part of a pile joint of claim 1, comprising one or more protrusions extending from an outside surface of the end plate on an outside of the cap, the protrusions being configured to be received within one or more corresponding indentations provided on an end plate of a second part of the pile joint when the pile joint is joined together.

5. The first part of a pile joint of claim 4, wherein a channel that is configured to receive a locking pin is provided in each protrusion.

6. The first part of a pile joint of claim 1, comprising one or more indentations situated on an outside surface of the end plate on an outside of the cap, the indentations being configured to receive one or more corresponding protrusions provided on an end plate of a second part of the pile joint when the pile joint is joined together.

7. (canceled)

8. The first part of a pile joint of claim 1, wherein the end plate and/or peripheral sidewall is/are configured to be welded to the end plate and/or peripheral sidewall of a second part of the pile joint.

9. The first part of a pile joint of claim 1, wherein the, or each, peripheral wall recess is configured to receive and retain a cover plate or a portion of a cover plate.

10. A kit comprising: the first part of a pile joint of claim 9; and at least one cover plate, the cover plate being configured to be, wholly or partly, received within and retained in a respective peripheral wall recess so as to cover the recess such that a channel defined by the peripheral wall and the cover plate is formed between the aperture and the end plate.

11. The kit of claim 10, wherein the at least one cover plate is configured to be fastened within the respective peripheral wall recess.

12. A kit comprising: the first part of a pile joint of claim 1; and at least two fluid conduits, each fluid conduit being configured to pass through a respective aperture.

13. The kit of claim 12, wherein each fluid conduit is configured to be embedded within a pre-cast driven pile segment and is configured to pass through a respective aperture of the first part of the pile joint once the first part of the pile joint is fitted to an axial end of the pre-cast driven pile segment.

14. A pile joint for joining geothermal pre-cast pile segments, the pile joint comprising:
the first part of the pile joint of claim 1;
and
a second part of the pile joint for joining geothermal pre-cast pile segments, the second part comprising:
a cap having an end plate and a peripheral wall extending from a periphery of the end plate, the end plate and peripheral wall defining a volume; and
at least two apertures passing through the cap, wherein each aperture provides a passage from inside of the cap to outside of the cap, and wherein each aperture is provided within a recess in the peripheral wall such that each aperture is thereby recessed within the volume defined by the end plate and the peripheral wall.

15. (canceled)

16. The pile joint of claim 14, wherein the, or each, recess on the first part of the pile joint is configured to align with a corresponding recess on the second part of the pile joint when the first part and the second part of the pile joint are joined together so as to define a passage that permits a fluid conduit associated with the first part of the pile joint and protruding from an aperture thereof and a fluid conduit associated with the second part of the pile joint and protruding from an aperture thereof to be housed and joined therein.

17. The pile joint of claim 14, comprising at least two connectors that are each configured to connect a fluid conduit associated with the first part of the pile joint and protruding from an aperture thereof with a fluid conduit associated with the second part of the pile joint and protruding from an aperture thereof.

18. A geothermal pre-cast driven pile segment comprising at least two fluid conduits embedded therein and the first part of a pile joint of claim 1 fitted at an axial end of the pre-cast driven pile segment, wherein an end of each fluid conduit protrudes through a respective aperture of the first part of the pile joint.

19. The geothermal pre-cast driven pile segment of claim 18, comprising a further first part of a further pile joint fitted at the other axial end of the pre-cast driven pile segment, and wherein the other end of each fluid conduit protrudes through a respective aperture of the further first part of the further pile joint, wherein the further first part of the further pile joint includes a cap having an end plate and a peripheral wall extending from a periphery of the end plate, the end plate and peripheral wall defining a volume, and at least two apertures passing through the cap, wherein each aperture provides a passage from an inside of the cap to an outside of the cap, and wherein each aperture is provided within a recess in the peripheral wall such that each aperture is thereby recessed within the volume defined by the end plate and the peripheral wall.

20. A geothermal pile structure, the geothermal pile structure comprising:
a first pre-cast driven pile segment having at least two fluid conduits embedded therein; and
a second pre-cast driven pile segment having at least two fluid conduits embedded therein;
wherein the first pre-cast driven pile segment and the second pre-cast driven pile segment are joined together with the pile joint of claim 14 such that each fluid conduit in the first pre-cast pile segment is connected to a respective fluid conduit in the second pre-cast pile to establish a fluid connection therebetween via a respective aperture in the first part of the pile joint and a respective aperture in the second part of the pile joint.

21. A method of manufacturing a first part of a pile joint for joining geothermal pre-cast driven pile segments, the method comprising:
forming a cap having an end plate and a peripheral wall extending from a periphery of the end plate, the end plate and peripheral wall defining a volume, wherein at least one recess is formed in the peripheral wall;
providing at least two apertures in the at least one recess such that the apertures are recessed within a volume defined by the end plate and the peripheral wall, wherein the at least two apertures each provide a passage from an inside of the cap to an outside of the cap.

22-24. (canceled)

25. A method of harvesting geothermal energy, the method comprising circulating fluid through fluid conduits of the geothermal pile structure of claim 20 such that thermal exchange is enabled between the fluid and surrounding ground within which the geothermal pile structure is installed.
